(19) United States
(12) Patent Application Publication
(10) Pub. No.: US 2021/0002953 A1
(43) Pub. Date: Jan. 7, 2021

(54) Recessed wings

(71) Applicant: Jonathan Locke, Bronx, NY (US)

(72) Inventor: Jonathan Locke, Bronx, NY (US)

(21) Appl. No.: 16/501,892

(22) Filed: Jul. 1, 2019

(51) Int. Cl. E06B 9/323

(52) U.S. Cl. CPC E06B 9/323

(57) ABSTRACT

The present invention is a unique modification for a headrail mechanism designed to control and install a variety of window treatments, such as vertical blinds, shades and/or other types of window treatments. The present invention consists of adding a set of recessed flanges to certain headrails, known as “Recessed Wings” enabling the user to install certain headrails used for window treatments in a recessed and secured fashion. This Invention enabled the user to install certain window treatment in a safe and secure way that enhances the aesthetic appeal and provided a finished and smooth look. This specific invention is known as “Recessed Wings” and shall be referred to as “Recessed Wings” or the “Invention,” in this utility patent application.

### A BRIEF DESCRIPTION OF THE DRAWINGS

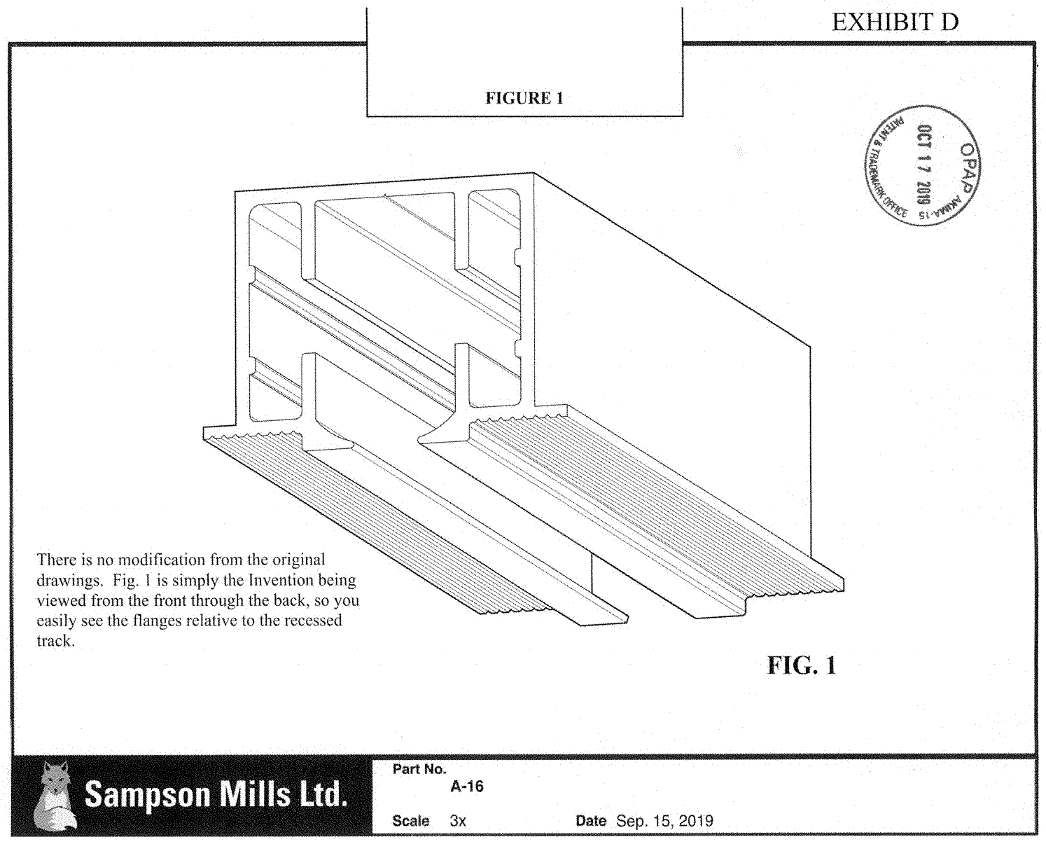

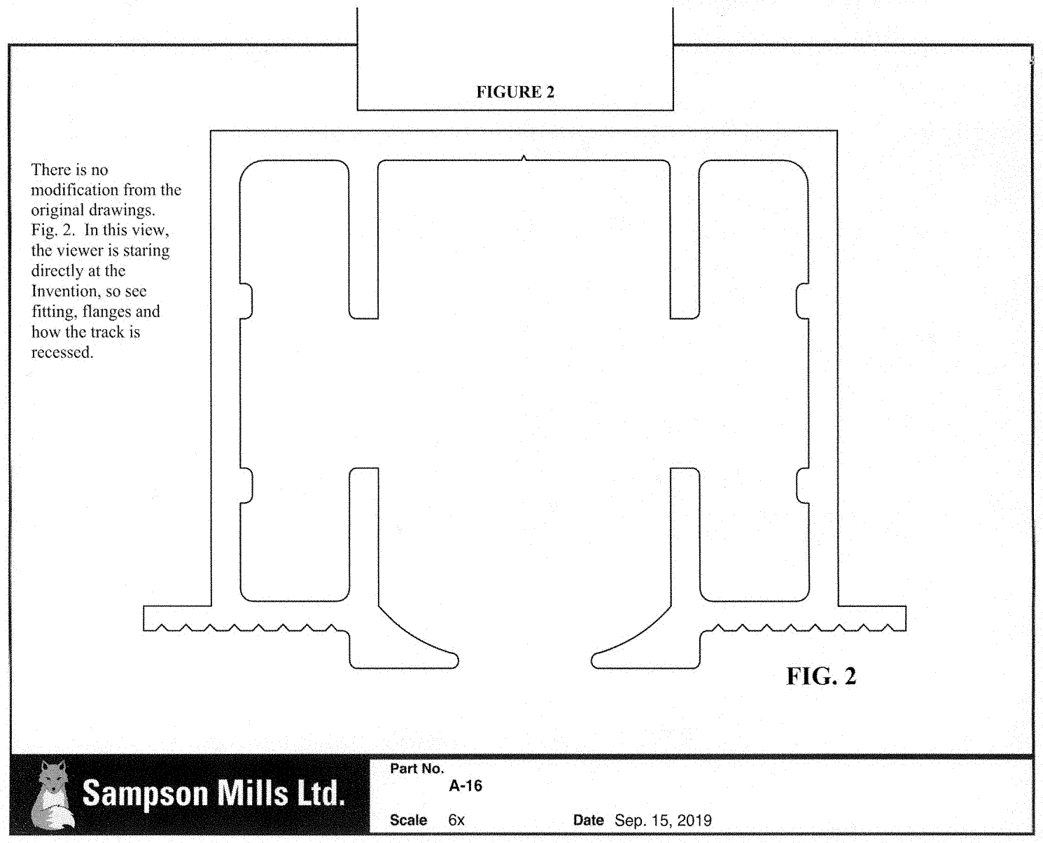

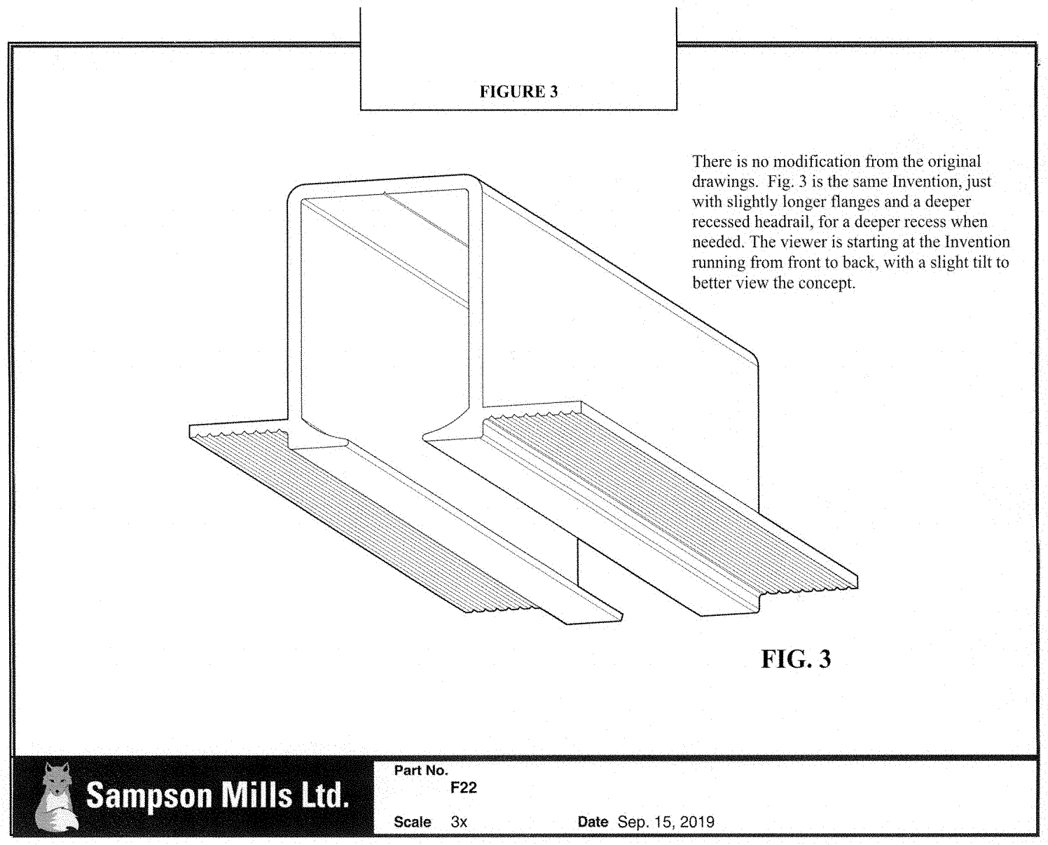

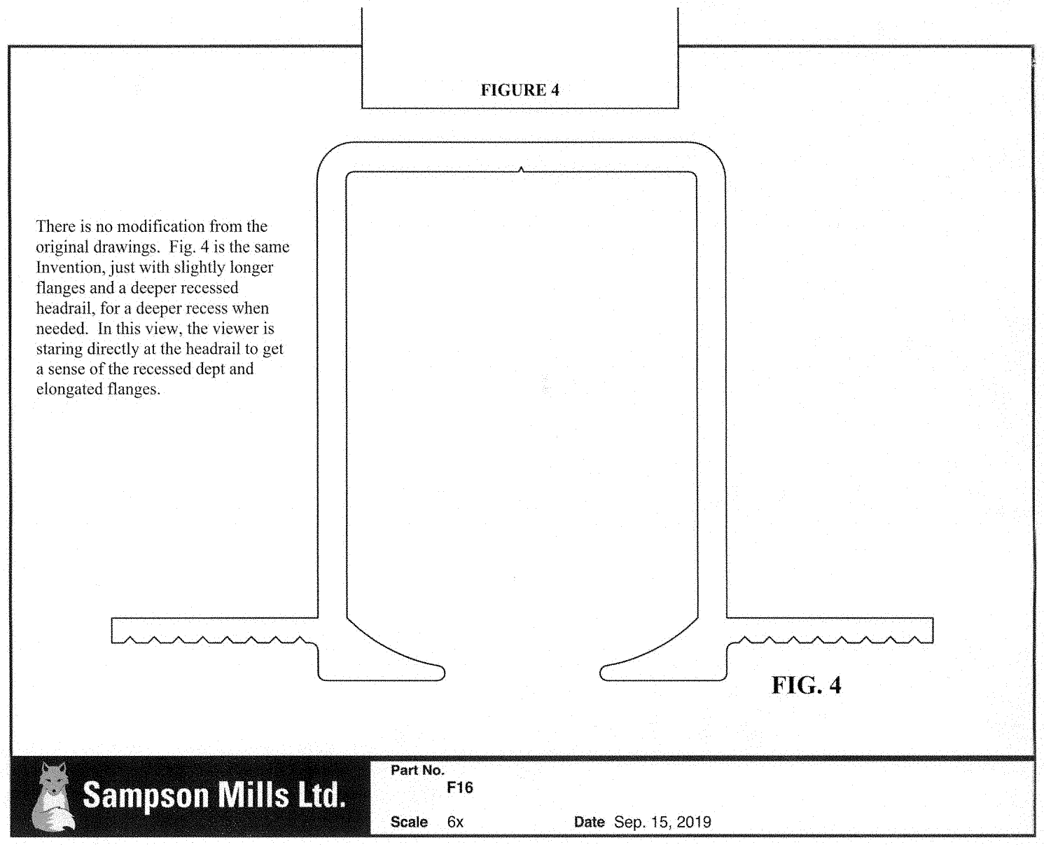

Attached to this application are stand alone images labeled FIG. 1, FIG. 2, FIG. 3, and FIG. 4 (collectively, the “Drawings”).

The image identified as Image 1 is an image of the invention in its entirety. The Invention contemplated by this utility patent application are the specific flanges identified as “Left Flange” and “Right Flange,” and their particular recessed position on the headrail. The Drawings represent the Invention used in two (2) different situations.

In FIG. 1, you are staring directly at the Invention, running from front to back, with a slight tilt to the right of the image. In FIG. 2, you are simply staring directly at the Invention, as if it were placed directly in front of you, with the opening in your face, running back. Across the horizontal plane you will observe from left to right, a left wing, a square shaped headrail, bottom portion open partially for the insertion of the installation equipment, then the right wing. The left and the right wing, along with their location on the headrail, are the unique elements of this Invention.

In FIG. 3 and FIG. 4, in order to accommodate for greater depth, the square shaped headrail has been slightly modified to a rectangular shaped headrail. Similar to FIG. 1, in FIG. 3, you are still staring directly at the Invention, running from front to back, with a slight tilt to the right of the image. In FIG. 4, you are simply staring directly at the Invention, as if it were placed directly in front of you, with the opening in your face, running back. Across the horizontal plane you will observe from left to right, a left wing, a rectangular shaped headrail, bottom portion open partially for the insertion of the installation equipment, then the right wing. The left and the right wing, along with their location on the headrail, are the unique elements of this Invention.

This Invention permits the headrail to be safely secured between two pieces of building material (i.e. sheetrock, panel, wonder board, etc.), while both wings will touch the physical surface of the building material on both the left and right side of the track. The left wing and the right wing are known as “flanges” (note that the term “flanges” and “wings” will be used interchangeably in this description). The flange with sit directly on the facial surface of the building material to the left and right of the recessed headrail, and it will have a slight recess of about 1/16^{th} of an inch, which will allow for the user to surface mount the headrail, and then use plaster or compound over the flanges, to give it a finished looked. The end result is that the building material on each side of the headrail will seamlessly transition into the headrail, and give the user a finished look so there is no observable difference between the headrail and the building material.

You will notice that the flange is designed to overlap and rest on the surface of the finished building material. The amount of overlap is expected to be between ½ inch and 1 inch depending on the unit purchased. You will also notice that the flange is set recessed from the visible surface of the headrail by approximately 1/16 of an inch. The purpose of the slight recess is to enable the user to tape or plaster the edge, giving the product a finished look and smooth transition from the finished building material into the headrail.

### THE INVENTION IN DETAIL

As referred to and visually represented in the collective Drawings, the present Invention known as “Recessed Wings” is a unique modification for a headrail mechanism, more commonly known as a “track,” which permits the user to install the headrail in a recessed fashion, so the finished product can look flush and seamless with the surrounding material. Typically, the user will want to install this into the ceiling, however other uses may be desirable for the user.

The trends in the industry today are moving toward a more seamless and cleaner look. End users and customers no longer want to see the actual mechanism after installation. The actual track serves as an eyesore for the customer, and the more aesthetically appealing design is one that is barely noticeable.

The present Invention contemplates a specific modification to the existing headrail systems, which enables a headrail mechanism to be recessed, and installed in a discrete fashion. In order to do so, the present Invention employs a pair of horizontal flanges on the sides of the headrail that permit the user to best recess and hide the unappealing, unaesthetic headrail. In addition, the flanges allow for a short 1/16 recess on the visible service, so that the end user or installer may apply a finish layer of plaster or compound over the flange, and give it the appearance of it flowing seamlessly into the surrounding material. Finally, the addition of the flanges on the left and right side of the headrail add an element of stability to the system during installation. Stability of the system ensures that the possibility of cracks from hardened plaster or compound, shifting of the connected material, or any other imperfection associated with the installation of the headrail will be greatly reduced.

As stated above, what makes this Invention unique are the recessed flanges on the left and right side of the headrail. The flanged qualities are set up in such a way that permits the user to effectively conceal the unappealing and unaesthetic headrail. This unique Invention, enabling the user to conceal the headrail, can be used with motorized or non-motorized window treatments. Such window treatments can include vertical blinds, curtains, shades and essentially any kinds of fabrics requiring the use of a track or headrail.

Another unique component of this Invention is that the flanges are recessed on the visible surface of the headrail of about 1/16^{th} inch. This is to enable the user to apply plaster, joint compound, or any other finish material to ensure a finished, sleek and seamless transition. The 1/16^{th} inch recess was also strategically placed as a depth of 1/16^{th} will reduce the possibility of cracking should the end user or installer desire plaster or joint compound.

### SUMMARY OF THE SPECIFIC ADVANTAGES OFFERED BY THE INVENTION

The invention descried herein has three (3) primary advantages to the user.

1. Aesthetically Pleasing Design.

As stated, the trends in the industry today are moving toward a more seamless and cleaner look as it concerns window treatments. End users and customers no longer want to see the actual mechanism once installed, but rather, would prefer the mechanisms to be hidden, and only the actual fabric, slots or blinds to be visible. Customers see the actual headrail as an eyesore, and the more aesthetically appealing design is one that is barely noticeable.

2. Easier Installation for the User.

While most headrails for window treatments typically require brackets to be installed in the frame prior to attaching the headrail, by the addition of the flanges, the user or installer, can simply install the headrail in a flush mounted fashion, right on the visible surface of the building material. The flanges that protrude out between ½ inch and 1 inch enable the user to fasten the headrail directly to the face of the building material, by nailing or screwing through the actual flanges, directly into the building material. An alternative method of installation is that the user can use glue, or some other sort of construction adhesive, and place it on the top of the flange (the side that will be flush mounted to the building material) and simply press the headrail into the desired location between the building material, encourage and enabling installation directly on the face of the building material.

3. Reduced Risk of Future Damage.

By providing a recessed flange that protrudes out between ½ inch to 1 inch, it provides the user or installer with ample room to apply as many fasteners as necessary to ensure that the headrail stays in place. In addition, the application of joint compound, plaster, or some other sort of flexible material like acrylic or silicone, gives it additional stability, to ensure a long lasting, perfected and finished look.

The invention claimed is as followed:

1. A set of recessed flanges that can be attached to a headrail, otherwise known as a window treatment track, designed for use on vertical blinds, venetian blinds, roller shades, roman shades, and curtains, whether motorized or non-motorized. The recessed flanges will run along the length of the desired headrail. The flanges are to be recessed 1/16^{th} of inch from the visible surface of the headrail, and are to protrude out from the headrail between ½ of an inch, to 1 inch, depending on the specifications of the user. The thickness of the recessed flanges can be between 1/16^{th} of an inch to ¼ of an inch, depending on the specifications of the user.

2. The device as set forth in claim 1 may be manufactured out of aluminum, brass, copper, steel, iron, plastic, acrylic, polystyrene, polycarbonate, polyethylene, polypropylene, or plyvinyl chloride (“PVC”)

3. Specifically, the device as set forth in claims 1 & 2, to be attached to a headrail designed for vertical blinds, whether motorized or non-motorized;

4. Specifically, the device as set forth in claims 1 & 2, to be attached to a headrail designed for venetian blinds, whether motorized or non-motorized;

5. Specifically, the device as set forth in claims 1 & 2, to be attached to a headrail designed for roman shades, whether motorized or non-motorized;

6. Specifically, the device as set forth in claims 1 & 2, to be attached to a headrail designed for roller shades, whether motorized or non-motorized;

7. Specifically, the device as set forth in claim 1, to be attached to a headrail designed for curtains, whether motorized or non-motorized;
